(19) United States
(12) Patent Application Publication
(10) Pub. No.: US 2008/0289832 A1
(43) Pub. Date: Nov. 27, 2008

(54) Automatic Directional Fire Suppression Device

(76) Inventors: David William Schimpf, Summerville, SC (US); Nuttawut Chevamongkol, Bangkok (TH); Charn Wongprecha, Bangkok (TH)

Correspondence Address: STEVEN L. NICHOLS;RADER, FISHMAN & GRAUER PLLC, 10653 S. RIVER FRONT PARKWAY, SUITE 150, SOUTH JORDAN, UT, 84095, US

(21) Appl. No.: 11/753,343

(22) Filed: May 24, 2007

(51) Int. Cl. A62C 35/02

(52) U.S. Cl. 169/51; 169/28

(57) ABSTRACT

An automatic directional explosive-type fire suppression device includes a container formed from two complimentary sections comprising a shield and a base; a fire extinguishing agent contained within the container; and an explosive charge assembly contained within the container. A portion of the shield is extended outward at an angle forming a skirt such that activation of the explosive charge within the container shatters the base and the fire extinguishing agent is automatically dispersed downward within a range of angles controlled by the skirt to extinguish or suppress a fire.

### BACKGROUND

Fire-fighting devices in general use at present are subject to numerous limiting factors with respect to their cost of acquisition, placement, storage, deployment for fire-fighting, or fire suppression, and other factors. By their nature, they may require periodic inspection by qualified, knowledgeable persons, training or esoterically detailed familiarity in their use, are typically bulky and/or require, as centralized sensing and extinguishing systems, extensive, expensive installation to afford the protection they are designed to provide.

A fixed installation of fire fighting, such as a sprinkler system, is subject to high installation costs, and may fail to effectively fight fires due to limited water supplies, sedimentary clogging of water supply piping, or failure to install sprinkler heads with sufficient coverage areas throughout an facility, among other factors. Sprinkler systems are designed to protect the integrity of the building and not the occupants or contents inside the premises.

As a result, there have been attempts in developing small fire fighting devices both manual as well as automatically activated so as to overcome such limitations. One of the commonly known devices is a pressurized dry chemical extinguisher, which is relatively heavy due to the prerequisite of its pressurized container. This device is relatively bulky in size and thus a limited number are typically available at a particular location. In use, it requires user's good judgment and courage to direct the stream of chemical spray toward the fire making the device's efficiency user dependent. That is, the device is only effective with a user with good physical and mental state during an emergency. In addition, due to its limitation in number, there may be only one extinguisher in the entire building or on each floor. Thus, in the event of a fire, access to the device may not be possible if there is a fire between the device and the user.

Automatic or self-explosive fire suppressing devices are also known. These devices have demonstrated good efficiency in controlling a localized blaze. Still, these devices have also shown limitations in costs either in manufacturing or acquisition, and method of deployment. Most importantly, in some devices, the dispersal pattern of the chemical can be less than uniform or ideal which reduces the device's effectiveness in controlling the fire. It also known in the industry that residue of fire extinguishing media can cause damages to properties adjacent to the fire, if the fire extinguishing media comes in contact with them during fire suppression, even though these properties may not be destroyed by the fire. In addition, in some devices the force of explosion releases hazardous flying debris.

U.S. Pat. No. 6,056,063 disclosed a thermo-controlled, self-explosive fire extinguisher which comprises a container contained fire extinguishing agents therein. The fire extinguishing agent expands when hot and the container explodes when it's inside pressure surpasses a predetermined level, causing the fire extinguishing agent to be spread out widely. One of the drawbacks of this device is that the blast does not produce uniform coverage of the fire extinguishing agent into a specific area as intended. In addition, is the fact that the device is designed to be installed on the ceiling. In order for the fire extinguishing agent to expand, there must be a rise in the ambient room temperature. This means that the fire must have been substantially large to cause such effect, accordingly, a substantial damage to the property has already been done before the activation of the device. Another drawback is that if more than one device is installed in the room, there is a likelihood that the rise in the room temperature will activate all the devices at the same time even if fire did not reach that particular section of the room, property in those section of the room unaffected by fire would also then have a potential to be damaged by the fire extinguishing agent

U.S. Pat. No. 6,796,382 disclosed an explosive-type fire extinguishing ball of which fire extinguishing materials are contained in the containment vessel and an explosive device is contained within the containment vessel, whereby activation of the explosive device breaks the containment vessel and disperses the fire extinguishing material with an omni-directional dispersal pattern. In addition, the invention is intended to be projected by hand, e.g., tossed, rolled, dropped or otherwise delivered directly into the vicinity of a fire by hand. Thus, there is a chance that the device would keep rolling past the fire, so that the fire extinguishing agent dispersed subsequently does not help to suppress the burning fire and there is a risk of flying debris to the non-fire zone. A problem also exists where this device contains two external fuses, on opposite sides, which are internally connected thus giving the potential of sending a lit fuse from the opposite side of the detonating fuse section to an area which is not on fire thus creating another fire hazard.

Therefore, there is a need for an automatic explosive-type fire suppressing devices that is economic to install, inexpensive to acquire, safe and easy to operate and efficiently delivers the fire extinguishing agents directionally into the fire so as to effectively suppress a localized fire and to minimize potential damage caused by excess dry fire extinguishing media.

### SUMMARY

An automatic directional explosive-type fire suppression device includes a container formed from two complimentary sections comprising a shield and a base; a fire extinguishing agent contained within the container; and an explosive charge assembly contained within the container. A portion of the shield is extended outward at an angle forming a skirt such that activation of the explosive charge within the container shatters the base and the fire extinguishing agent is dispersed downward within a range of angles controlled by the skirt to extinguish or suppress a fire.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIG. 1 shows a complete installation of the automatic directional explosive-type fire suppression device according to one embodiment of the present disclosure;

FIG. 2 shows a disassembled side view of an embodiment of the container of the automatic directional explosive-type fire suppression device according to the present disclosure with an explosive charge assembly;

FIG. 3 shows a sectional side view of an embodiment of the automatic directional explosive-type fire suppression device according to the present disclosure assembled to a mounting bracket assembly;

FIG. 4 shows a sectional side view of the shield of the container of the automatic directional explosive-type fire suppression of FIG. 1 and an embodiment of engagement means for securing the shield to the mounting assembly and said engagement means is featured as screws;

FIG. 5 shows an embodiment of engagement means for securing the shield of the container of automatic directional explosive-type fire suppression device according to an embodiment of the present disclosure, said engagement means is featured as a combination of hinge and release pin;

FIG. 6 shows an embodiment of engagement means for securing the shield of the container of automatic directional explosive-type fire suppression device according to an embodiment of the present disclosure, said engagement means is featured as lock pins;

FIG. 7 shows an embodiment of engagement means for securing the shield of the container of automatic directional explosive-type fire suppression device according to an embodiment of the present disclosure, said engagement means is featured as Velcro straps;

FIG. 8 shows an embodiment of engagement means for securing the shield of the container of automatic directional explosive-type fire suppression device according to an embodiment of the present disclosure, said engagement means is featured as screws;

FIG. 9 shows an embodiment of engagement means for securing the shield of the container of automatic directional explosive-type fire suppression device according to an embodiment of the present disclosure, said engagement means is featured as locking keys;

FIG. 10 shows an embodiment of the mounting bracket assembly according to the present disclosure and an embodiment of the shield of the container and an embodiment of engagement means for securing the shield to the mounting bracket assembly, said engagement means is featured as molded insert;

FIG. 11 shows different views of directional blast pattern and coverage area of the automatic directional explosive-type fire suppression device according to the present disclosure;

FIG. 12 shows different embodiments of engagement means for securing the shield of the container of the automatic directional explosive-type fire suppression device to the mounting bracket assembly according to the present disclosure;

FIG. 13 shows different embodiments of the container of the automatic directional explosive-type fire suppression device according to the present disclosure;

FIG. 14 shows further embodiment of the container of the automatic directional explosive-type fire suppression device according to the present disclosure;

Throughout the drawings, identical reference numbers designate similar, but not necessarily identical, elements.

### DETAILED DESCRIPTION

The present disclosure relates to fire extinguishing devices. In particular, the disclosure relates to a device that is automatically activated and directionally disperses fire extinguishing agent downward to extinguish or suppress localized fire.

Consequently, the present disclosure described, among other things, an automatic directional explosive-type fire suppression device comprising; a container formed from two complimentary half sections featured as a shield and a frangible base; a fire extinguishing agent contained within the said container; and an explosive charge assembly contained within the said container; wherein a portion of the shield is extended outward at an angle forming into a skirt, whereby activation of the explosive charge contained within the said container shatters the frangible base; and by the aid of the skirt, the fire extinguishing agent is directionally dispersed downward to extinguish or suppress a fire.

This provides an inexpensive, safe, easy to operate fire suppression device, which, while being of the explosive-type, is designed for stationary protection of designated objects or areas and upon activation of the device, the fire extinguishing agent is automatically and specifically directed downward to the designated objects or areas reducing potential damages to property adjacent to the fire caused by the residue of the fire extinguishing agent.

The present disclosure describes, among other things, embodiments of a fire suppression device designed for stationary protection of specific objects or areas designated as high fire hazard locations such as electrical circuitry, power equipment and battery supplies in a computer, electrical, telecom or electronics room, etc. The device can be used situated above these locations such that upon activation of the device the fire extinguishing agent is delivered specifically to the location which causes the device to activate and effectively suppress fire at its initial stage reducing the possibility of the residue of the fire extinguishing agent causing damages to the adjacent equipment or entire room as in the traditional multi-purpose, omni-directional fire extinguishing devices or systems.

The exemplary devices according to the present disclosure can be used in a building interior or localized exterior locations that are high fire risk areas and, through the device design, the device has little effect on aesthetic appearance of the location. The device can be installed as a stand alone device at the designated area throughout the premises where large scale fire protection is not available due to economic constraints. The device can also be installed as a complimentary system to the traditional fire extinguishing device or systems. This applies to large industrial applications as well as smaller private properties or even to the home owner whereby the device according to the present disclosure is installed in a high fire risk location in addition to the existing fire extinguishing devices or systems.

Various embodiments of an exemplary automatic explosive-type fire suppression device according to the present disclosure may include following features:
a frangible container for containing a fire extinguishing agent or combination of one or more fire extinguishing agents wherein upon activation of the device the fire extinguishing agent contained therein is directionally and evenly dispersed in a downward direction to suppress a fire;
fire extinguishing agents such as the types that are commercially available, especially a dry power type whether in single or multiple component combination;
an explosive charge assembly equipped with low explosive yield, with an insufficiently large force to cause injury to humans in the vicinity of explosion but with sufficient force to cause the base portion of the container to burst releasing the fire extinguishing agent contained in the container downward into the fire,
a bracket assembly for supporting the container in place as well as securing the device to a structure such as a wall.

In an exemplary embodiment of the automatic explosive-type fire suppression device described herein, the container comprises two complimentary half section features as a base and a directional shield.

The base being a non-hazardous single hemi-spherical shape made of a light weight, low density, rigid material which provides ideal fragmentation and uniform blast pattern. The base is prepared with an opening so as to allow the fuse of the explosive assembly to be threaded through as well as to accept the fire extinguishing agents to be filled into the container during the assembly of the device. A plug of the corresponding size and shape is also provided to close the opening after the assembly is completed.

The shield is also a hemi-spherical shape corresponding to the base so as to accept engagement of the base to the shield to form a complete container. The shield made of a molded lightweight material with high density that is heat resistant and strong enough to contain the explosive force without deforming and is configured such that during explosion the shield directs the fire extinguishing agent toward the designated downward direction.

The explosive charge assembly contains a fuse placed inside the container in a vertical direction having the first end of the fuse secured to the shield and the second end of the fuse extending through the opening prepared in the base and secured externally. In an event of a fire, the fuse is ignited and causes the detonation of the explosive charge and in turn causes the base to burst dispersing the fire extinguishing agent downward onto the fire.

The bracket assembly comprising a main body for securing the assembly by mounting to a structure such as a wall, a mounting ring, having a ring size corresponding to the size of the base, extends from the body and a pair of braces set across the ring to support mounting of the container into the bracket assembly.

In installation, the bracket assembly is located at the designated area for which fire protection is desired. The complete assembly of the container with the fire extinguishing agent and the explosive charge assembly contained therein is positioned into the bracket assembly such that the shield section is vertically positioned on top and the base section in the bottom of the mounting ring. The shield is positioned above the mounting ring having the edge portion of the shield meet with mounting so as to permit securing the shield to the bracket assembly to prevent unintentional removal of the device. In an event of a fire, the fuse is ignited and causes the explosion of the explosive charge and in turn causes the base to explode dispersing the fire extinguishing agent into the fire.

In another embodiment of the automatic directional explosive-type fire suppression device according to the present disclosure, the shield is configured with an external support ring independent from the bracket which aids in attaching the base to the shield. In this embodiment, a set of braces are included and are attached to the shield instead of to the mounting ring as in the previously described embodiment.

In another embodiment of the automatic directional explosive-type fire suppression device according to the present disclosure, the shield is provided with a locking threaded key bolt which enters through the corresponding threaded opening provided in the center of the top of the shield. The threaded key bolt has an eyelet or a hook to allow suspending the automatic explosive-type fire suppression device above the desired objection or location which fire protection is required when a wall mount is unavailable.

In another embodiment of the automatic directional explosive-type fire suppression device according to the present disclosure, the shield is configured into a decorative design such as a star shape while the ability to directionally and uniformly disperse the fire extinguishing agent is maintained.

In another embodiment of the automatic directional explosive-type fire suppression device according to the present disclosure, the base and the shield of the container may be configured to be of a different geometric shape such as a polygon or a cylinder.

In yet another embodiment of the automatic directional explosive-type fire suppression device according to the present disclosure, the mechanism of securing the shield to the bracket assembly to include molded insert, tie-wraps, screws, a combination of a hinge with a release pin, release pins, Velcro fastener, hook and a combination of the aforesaid and a lock key or the like. An additional mechanism of securing the shield to the bracket assembly is by an independently provided molded section of the shield which accepts a single bracket bar for stabilization instead of the wire ring for support.

In the present description, for purposes of explanation, numerous specific details are set forth in order to provide a thorough understanding of the present devices and methods. It will be apparent, however, to one skilled in the art that the present devices and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

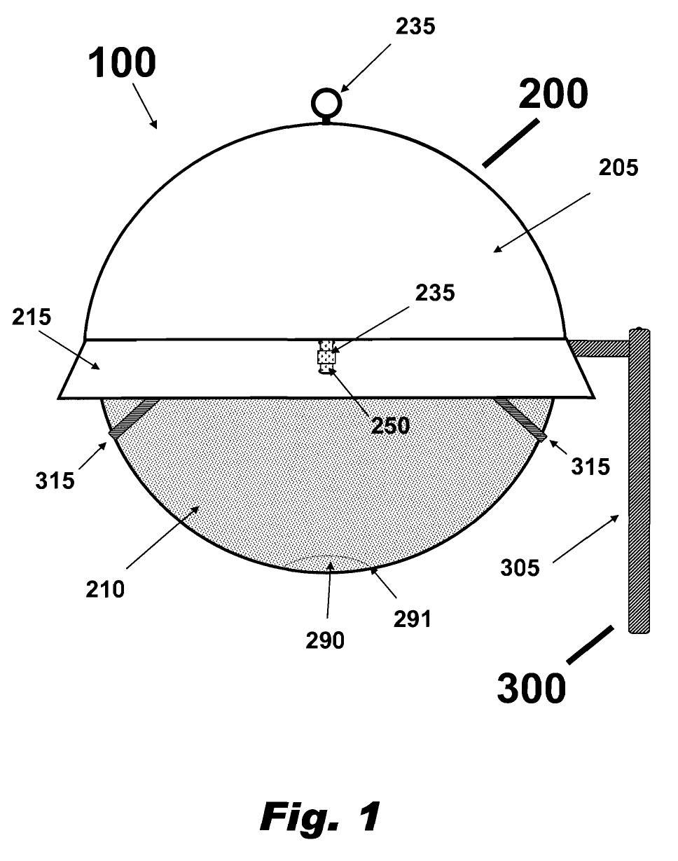

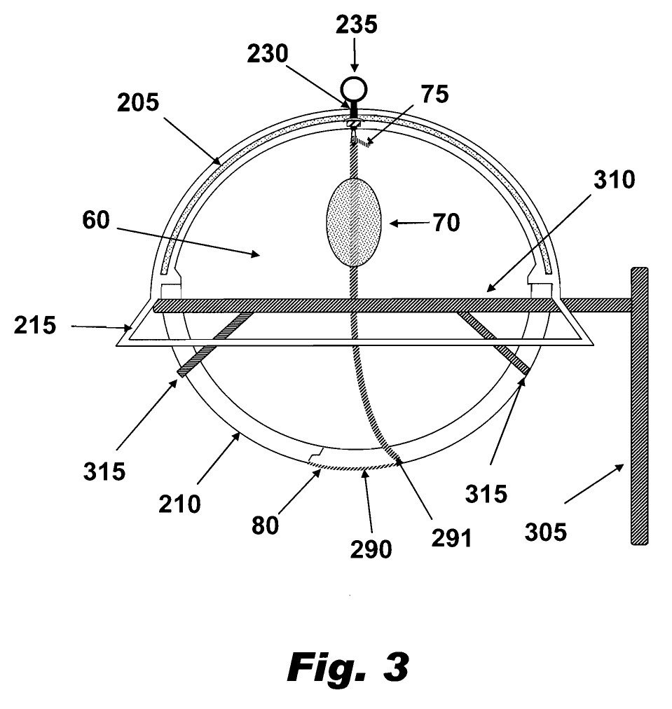

We now refer to the drawings. As shown in FIG. 1, an exemplary automatic directional explosive-type fire suppression device (100) according to principles described herein comprises a container (200) with a directional shield (205), a fire extinguishing agent (60, FIG. 3) or a combination of more than one fire extinguishing agent contained inside the container (200), an explosive charge assembly (70, FIG. 3), and a mounting bracket assembly (300).

The container (200) of the automatic directional explosive-type fire suppression device (100) according to the present disclosure comprises two complimentary sections, i.e., the shield (205) and a base (210). The configuration of the shield (205) and the base (210) can be of a different shape, but essentially compliment one another such that the shield (205) and the base (210) can be coupled to one another by using suitable adhesive material or by means of a corresponding coupling element prepared on the rim of the shield (205) and the base (210) to form a tight and secure container (200) capable of holding a predetermined amount of a fire extinguishing agent (60) or a combination of fire extinguishing agents and the explosive charge assembly (70) contained therein.

In an exemplary embodiment of the automatic directional explosive-type fire suppression device (100) according to the present disclosure, as shown in FIG. 1, both the shield (205) and the base (210) are hemispheric in shape. This is advantageous because once the shield (205) and the base (210) are coupled to one another producing a spherical shape, the highest ratio of internal volume relative to surface area is obtained in order to maximize a uniform outward blast pattern while minimizing the size of the container (200).

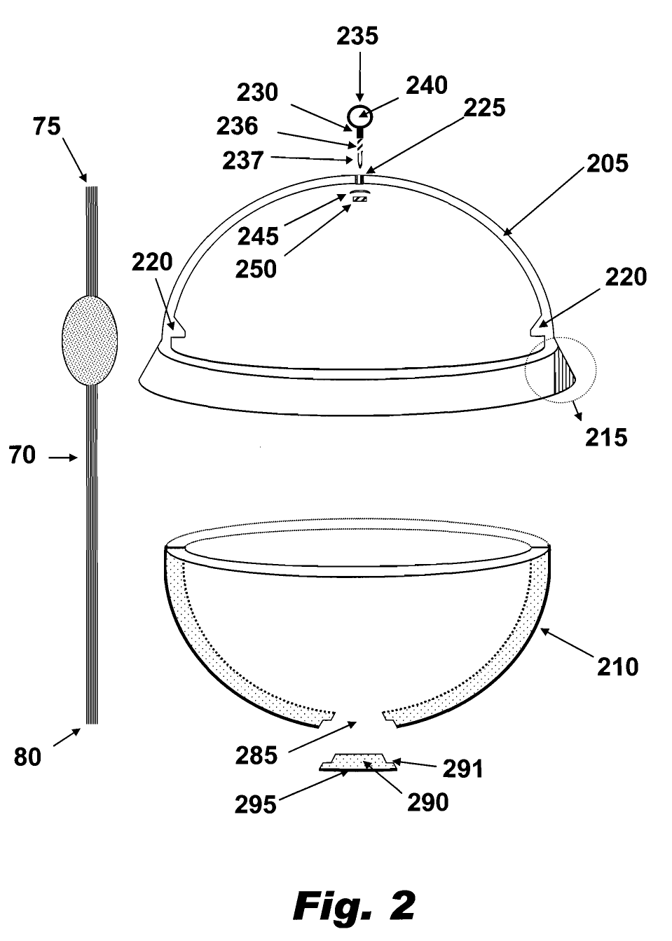

Referring to FIG. 2, the shield (205) can be made of molded light weight high density polyethylene or ethylene based materials or the like which are strong enough to withstand heat and contain the explosive force without deforming or cracking. The thickness of the shield (205) corresponds to the size of the hemisphere and the amount of the explosive yield desired for the application. Through molding, the shield (205) is configured such that the lower portion of the shield (205) is extended outward at an angle such that once the base (210) is coupled to the shield (205) the said lower portion overlap the rim portion of the base (210). For the purpose of explanation of the principles of this disclosure, the said feature will be referred to as a “skirt” (215). Above and next to the skirt (215), internal recesses (220) prepared on the shield (205) accept the portion of the rim of the base (210) when inserted or glued together in order to form a complete container (200). Other appropriate joint or coupling elements such as matching groove or tongue or the like may also be used for coupling or securing the shield (205) to the base (210). A precision hole (225) is prepared on the center of the top of the shield (205) which accepts a locking threaded suspension bolt (230). The locking threaded suspension bolt (230) features an external head (235) with a round eyelet (240) and a threaded tail portion (236) with a slot (237) which will accept a first end of the fuse (75) of the explosive charge assembly (70) as shown in FIG. 3. The threaded tail portion (236) of the locking threaded suspension bolt (230) enters the hole (225) prepared on the center of the top of the shield (205). Rubber washer (245) and nut (250) are provided to internally secure the threaded suspension bolt (230) to the shield (205).

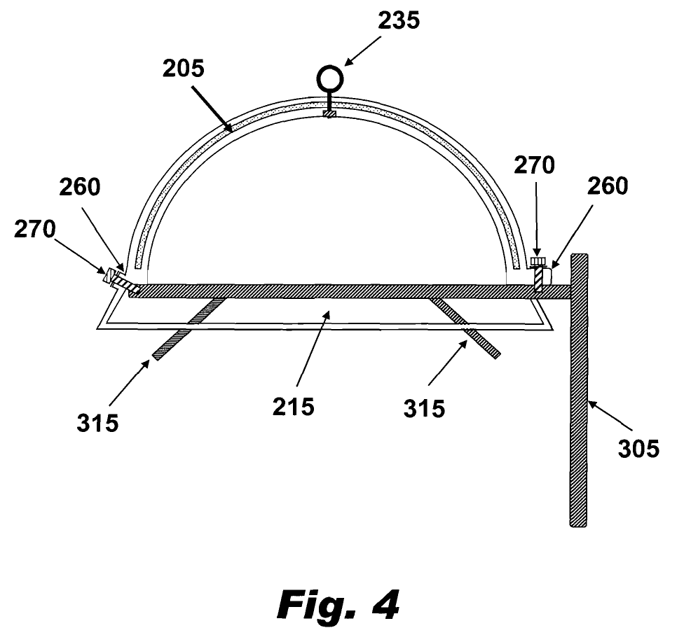

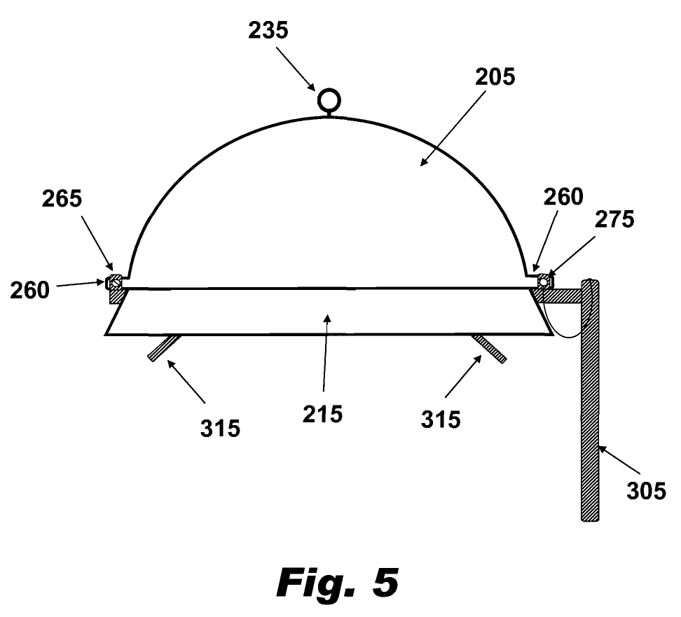

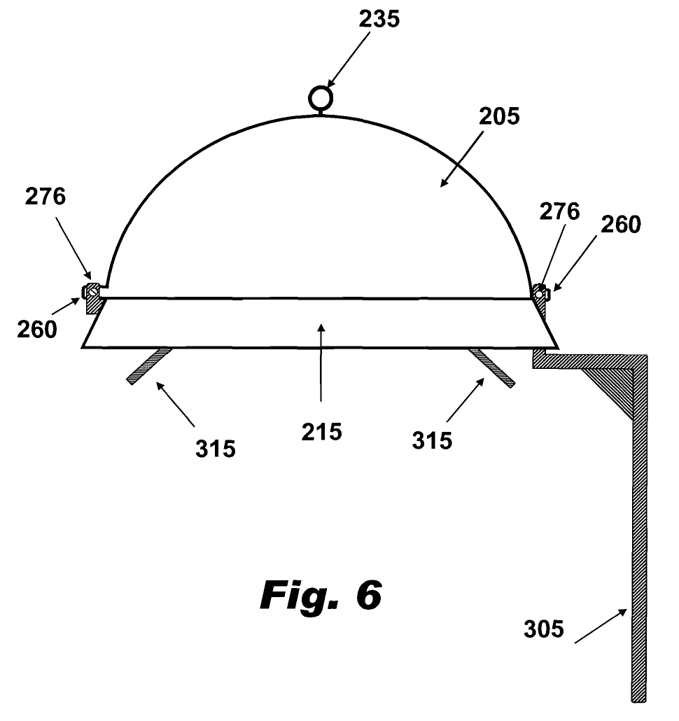

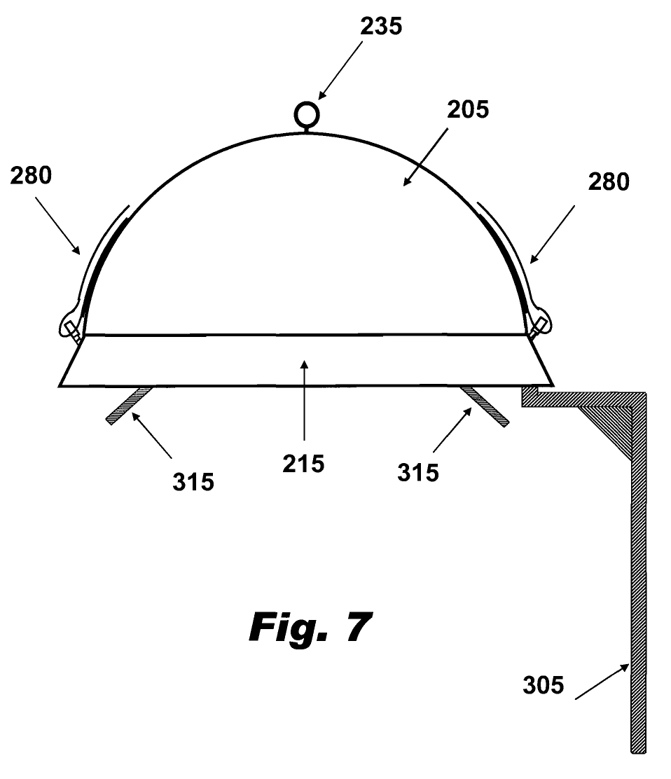

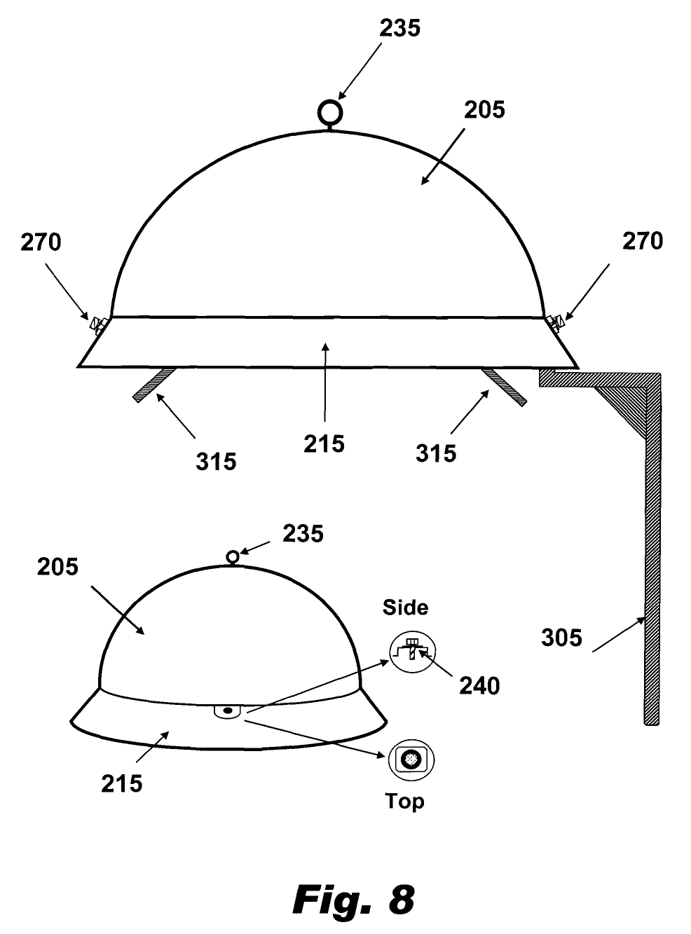

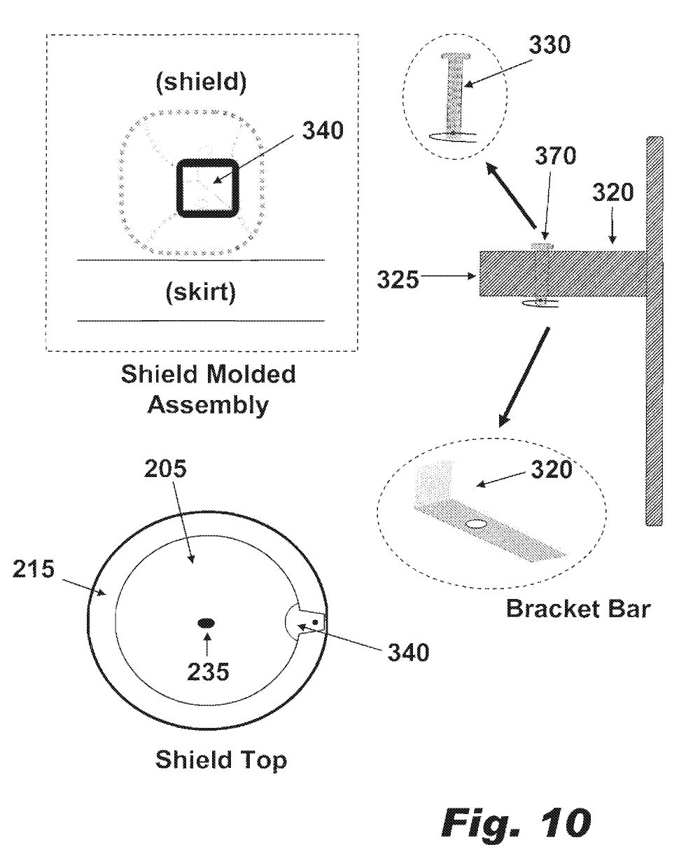

Through molding or post molding treatments, appropriate locking elements for securing the container (200) to the bracket assembly (300) are prepared on the rim portion or on the skirt (215) of the shield (205). According to one embodiment of the present disclosure, as shown in FIG. 1, small holes (250) are prepared to accept PVC tie-wraps (255) to secure the container (200) to the bracket assembly (300) for wall mounting. In another embodiment, moldings (260) are designed on the outer edge of the shield (205) above the skirt (215) in anticipation for receiving various locking elements such as a hinge (265), screw (270), release pin (275), lock pin (276) Velcro strap (280) or combination of such elements as shown in FIGS. 4-9. In another embodiment, the shield (205) is configured with a molded insert as shown in FIG. 10. The mechanism for securing the shield (205) to the bracket assembly (300) according to this embodiment will be described further below.

The base (210), as shown in FIG. 2, can be made of a non-hazardous frangible material. In some examples, the base (210) is constructed of a lightweight, low density, rigid material such as Styrofoam for ideal fragmentation and uniform blast pattern while minimizing risk of flying debris. A hemisphere shape can provide a predictable direction blast pattern. As mentioned above, the base (210) is coupled to the shield (205) with appropriate coupling elements. Thus, an appropriate coupling element corresponding to that prepared on the shield (205) must also be prepared on the base (210). An opening (285) is prepared on the center of the bottom of the base (210) for receiving fire extinguishing agents (60) and the explosive charge assembly (70). A matching fitted plug (290) is provided to seal the opening (285) after installation of the explosive charge assembly (70) and filling of the fire extinguishing agent (60) is completed. The second end of the fuse (80) of the explosive charge assembly (70) exits through a groove (291) made in the side of the plug (290) and is positioned in the section of the external groove (295) of the plug (290) on the base (210).

The fire extinguishing agents (60) for use with the automatic directional explosive-type fire suppression device (100) according to the present disclosure are such as the types that are commercially available, especially a dry power type whether in single or multiple component combination. The fire extinguishing agents (60) are filled into the container (200) with the explosive charge assembly (70) assembled therein wherein upon activation of the device the fire extinguishing agent (60) contained therein is directionally and evenly dispersed to suppress a fire.

The automatic directional explosive-type fire suppression device (100) according to the present disclosure is intended to deliver the fire extinguishing agent (60) by means upon which the second end of the fuse cord (80) exposed on the base (210) is ignited and subsequently activates the explosive charge whose explosive yield would explode and shatter the base (210) dispersing the fire extinguishing agent (60) directionally toward the blaze. A common explosive charge/detonator may be used. However, it is intended that the explosive charge assembly (70) must equipped with low explosive yield, insufficient to cause injury to humans in the vicinity of explosion but with sufficient force to cause only the base (210) of the container (200) to explode releasing the fire extinguishing agent (60) contained in the container (200) into the fire,

One of the objectives of the automatic directional explosive-type fire suppression device (100) is to mount the container (200) on a structure such as a wall using the bracket assembly (300), an embodiment of the bracket assembly (300) is as shown in FIG. 3. The bracket assembly (300) comprises of a body (305), a mounting ring (310) with supporting braces (315). The bracket assembly (300) is made of rigid material such as iron, aluminum, stainless steel, plastic or the like. The body (305) is formed into an elongated bar and the mounting ring (310) with a ring size corresponding to the size of the container (200) extended from the body (305). A pair of braces (315) is set across the mounting ring (310). The configuration of the braces (310) correspond to the shape and configuration of the base (210) of the container (200) wherein when a complete container (200) is positioned into the mounting ring (310), the base (210) sits inside the mounting ring (310) and the shield (205) sits above the mounting ring (310) and the skirt (215) of the shield (205) meet the outer side of the mounting ring (310) allowing easy securing the shield (205) (at the skirt (215)) to the mounting ring (310). In another embodiment of the bracket assembly (300), the body (305) of the bracket assembly (300) may be formed into a circular shape, such as a disc. In another embodiment, as shown in FIG. 10, the mounting bracket assembly (300) does not have a mounting ring (310), but the ring is replaced instead with a mounting bar (320) and the shield (205) is prepared with an external adjustable support ring (310) independent from the body (305) of the bracket assembly (300) which aids in attaching the base (210) to the shield (205). In this embodiment, the shield (205) is configured with a molded mating elements such as a female molded outlet insert (340) as shown in FIG. 10 of which the corresponding mating elements such as a male molded insert (325) is prepared on the mounting bar (320) of the bracket assembly (300) whereby the female molded insert (280) on the shield (205) is inserted into the male molded insert (325) of mounting bar (320) and the insertion is locked by using a insert pin (330).

The bracket assembly (300) for mounting the automatic directional explosive-type fire extinguishing device (100) according to the present disclosure, particularly the embodiment with the mounting ring, may be adapted for use with conventional automatic explosive-type fire suppression devices wherein the bracket assembly (300) according to the present disclosure is mounted onto a wall and the conventional automatic explosive-type fire extinguishing device is simply put inside the mounting ring (310) and cover with the shield (205) of the container according to the present disclosure.

As mentioned above, the shield (205) of the container (200) is provided with a locking threaded suspending bolt (230). Alternatively, the automatic directional explosive-type fire suppression device (100) can be suspended above the object or area for which fire protection is desired if a wall mounted location is unavailable or not applicable.

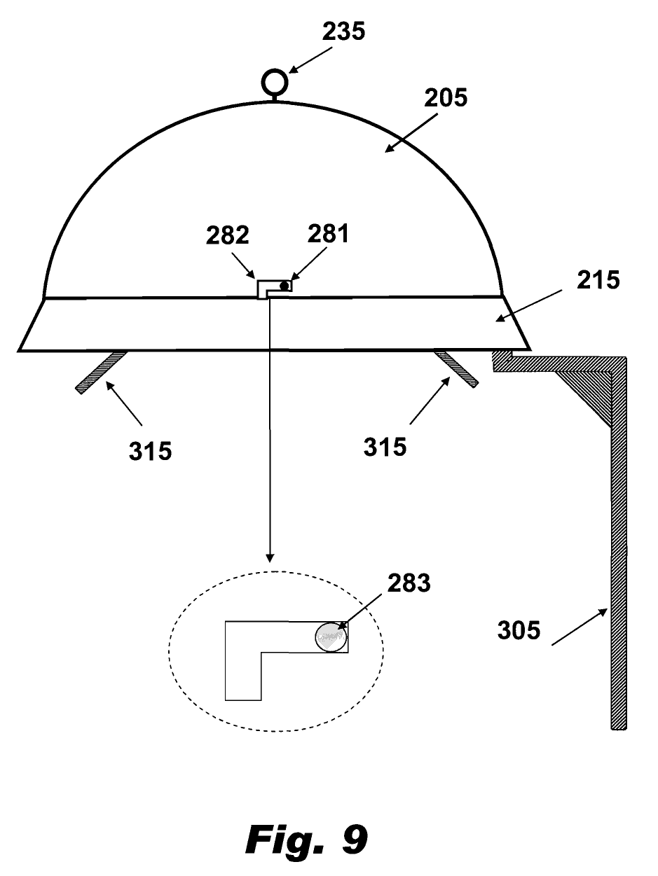

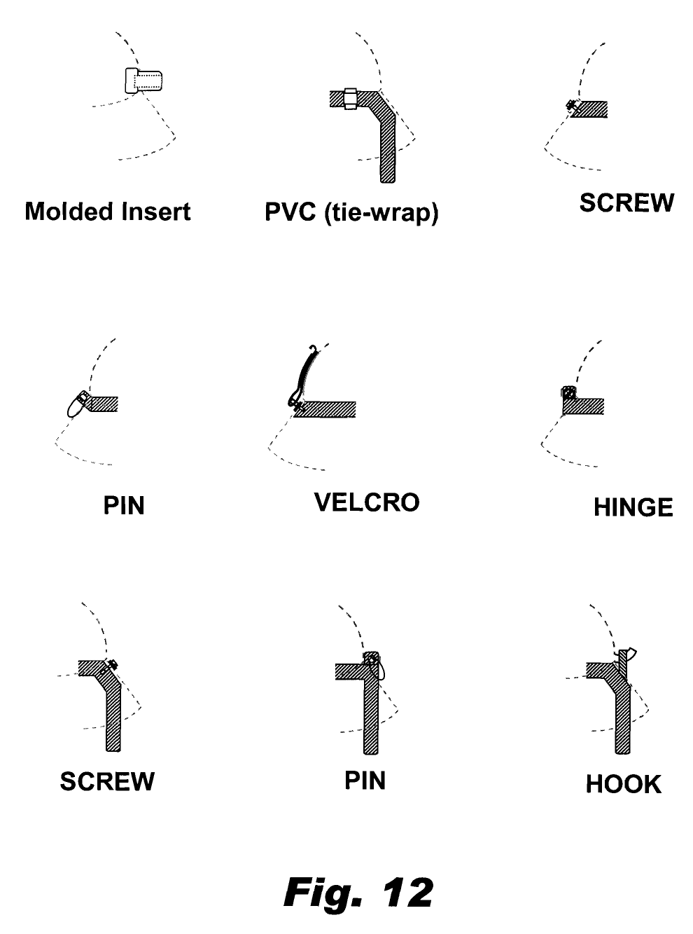

As mentioned above that in various embodiments, moldings (260) having mating/locking elements are made on the outer edge of the shield (205) above the skirt (215) in anticipation for receiving of various mating/locking elements such as a hinge (265), screw (270), release pin (275), Velcro strap (280) or combination of such elements as shown in FIG. 12 and a lock key (281) as shown in FIG. 9 for securing the shield (205) to the mounting ring (310). Thus, a corresponding mating feature of such mating/locking elements must also be prepared on the mounting ring (310) so as to secure the container (200) to the mounting ring (310), preventing unintentional removal of the device. Similar moldings may also be made on the skirt of the shield. In another exemplary embodiment, the shield (200) is secured to the mounting ring (310) by the locking key (281). As shown in FIG. 9, the shield is prepared with a locking slit (282) just above the skirt (215) and the mounting ring (310) is prepared with a locking stud (283) whereby by turning the shield (205), the slit (282) is shifted position and the locking stud (283) slid into the end of the slit securing the shield (205) to the mounting ring (310).

Assembly of the automatic directional explosive-type fire suppression device (100) according to the present disclosure starts with inserting the threaded locking suspension bolt (230) through the hole (225) in the center of the top of the shield (205), the head portion (235) with an eyelet (240) remain outside the shield (205), then turn the shield (205) up side down, from the inside thread the rubber washer (245) and nut (250) over the threaded tail (235) of the threaded locking suspension bolt (230) and tighten. Secure first end (75) of the fuse of the explosive charge assembly (70) to the slot (240) of the threaded locking suspension bolt (230). Then the base (210) and the shield (205) is coupled together by using suitable adhesive materials or by means of coupling elements prepared on the rim of the shield (205) and the base (210). The assembled container (200) has a second end (80) of the fuse of the explosive charge assembly (70) threaded through the opening (285) on the base. The second end (80) of the fuse is pulled tight and the excess fuse is temporary secured with a rubber band (not shown) or adhesive materials, such as adhesive tape to ensure that the explosive charge assembly (70) inside the container (200) is held in position. A predetermined amount of fire extinguishing agent (60), preferably a dry chemical fire extinguishing/fire suppressant powder is then filled into the container (200) through the opening (285) on the base (210) until the desire weight/volume ratio for the specific container's size is reached. Then, the fitted plug (290) is inserted into the opening (285) on the base (210) with the second end of the fuse (80) secured in the groove (291) between the base (210) and fitted plug (290) and then sealed using silicon adhesive. The rubber band or the adhesive tape that was used to secure the fuse temporarily is then removed. The second end (80) of the fuse is folded over and secured into the groove (295) prepared on the external side of the fitted plug (290) of the base (210), thus the second end (80) of the fuse cord is exposed on the external side of the container (200). The excess fuse is cut leaving the remaining fuse at the desired length. Thereafter, the base (210) is sealed with a lightweight cellulose film (not shown), or like materials, making it moisture impermeable. The film materials chosen must be suitable for the place of application of the device according to the present disclosure. For example, in an environment where the gasoline or petroleum or material that is gasoline or petroleum is likely to come in contact with the device, a special type of film that would not dissolve upon contact with such materials may be used.

In one embodiment of the present disclosure, the automatic directional fire suppression device (100) may be installed by mounting the device to a structure such as a wall using the mounting bracket assembly (300) as shown in FIG. 1. This is achieved by first mounting the bracket assembly (300) to the wall. The container (200) is then positioned into mounting ring (310) of the bracket assembly (300), having only the base (210) sits inside the mounting ring (310) and between the braces (315) which help to support the container (200) inside the mounting ring (310) and the shield (210) (the portion above the skirt (215) sits above the mounting ring (310). The shield (210) is secured to the mounting ring (310) to prevent unintentional removal of the device from the designated location. In another embodiment, the bracket assembly (300) does not have a mounting ring (310), the shield (205) and the bracket assembly (300) is simply secured together by using the molded insert as shown in FIG. 10, as previously described. Alternatively, the automatic directional explosive-type fire suppression device (100) according to the principles of the present disclosure may be installed above the objects or areas or devices which fire protection is desired, and a wall mount is not available or not practical, by suspending the device using a wire, rope, chain or the like to the locking threaded suspending bolt (230) located on the shield (205) to a structure above the location where fire protection is designated. The distance from the objects or areas or devices to be protected to the device should preferably in the range of 15-30 cm. The installation should be about 15-30 cm above the area, device to be protected. The installation is completed.

The device may be positioned 15-30 cm above the device or areas to be protected. However, the fire-suppression device can also be effective if positioned outside that range. As disclosed, one of the objectives is that the automatic directional fire suppression device (100) according to the present disclosure is designed to compliment larger fire prevention systems. Thus, the device is intended to target outbreak of a small or initial fire. When the device is positioned closer to the source of fire, the device would still activate even if only a small fire occurs. Accordingly, the likelihood of damage to the property is less because the fire is put out in its early stage. In a situation where fire protection for a large object or device or zone is desired, the size of the device may be increased accordingly so as to contain a larger amount of fire extinguishing agent sufficient to suppress a larger fire. Accordingly, the device may, in some examples, be installed higher than 30 cm above the designated object, device or zone.

In the event of a fire, the blaze would ignite the second end (80) of the fuse exposed outside the container (200) and subsequently cause the explosive charge contained inside the base (210) to explode and shatter the base (210) dispersing the fire extinguishing agent (60) contained therein into the blaze and its vicinity. Advantageously, the blast pattern and downward dispersal of the fire extinguishing agent is directional. That is, the fire extinguishing agent (60) is dispersed downward directionally to the designated zone, device or object. This is the result of the configuration of the container (200) of which the shield (205) is featured with a skirt (215) whereby the angle the skirt (215) would direct a downward dispersal of the fire extinguishing agent (60) to be dispersed within the range of the angle of the skirt (215) rather than dispersing the fire extinguishing agent (60) in all directions (omni-directional) as in most conventional automatic fire extinguishing devices in which the blast pattern lacks uniformity and the residue of the fire extinguishing media tends to damage property adjacent to the fire as well. The fact that the fire extinguishing agent (60) is delivered directly toward to the blaze, the chance of successfully suppressing the burning fire is greater and the risk of damages to property from residue of fire extinguishing agent (60) is minimized.

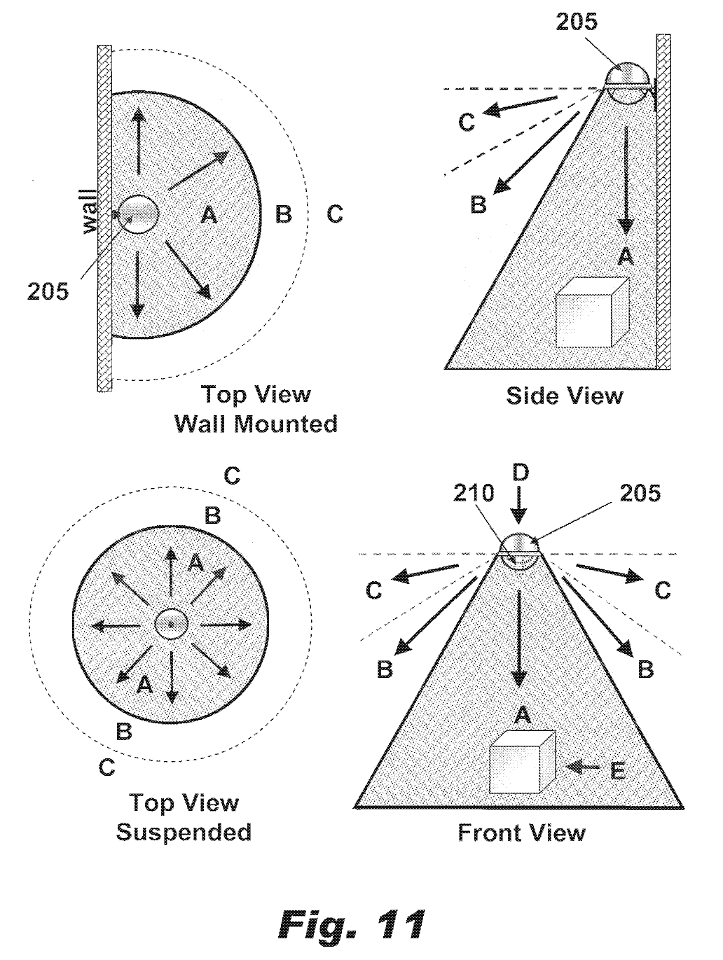

As shown in FIG. 11, the dispersal direction of the fire extinguishing agent (60) is directed by the angle of the skirt (215) feature on the shield (205) of the container (200) of the device according to the present disclosure. As shown, area A shows the intended coverage or directional path of dispersal of the fire extinguishing agent (60) which approximately 75% of the fire extinguishing agent (60) is directed to the area, and 20% to the area B and the remaining 5% to area C. This is a clear indication that the large percentage of the fire extinguishing agent (60) is delivered directly toward the blaze, thus, the chance of successfully suppressing the fire is greater.

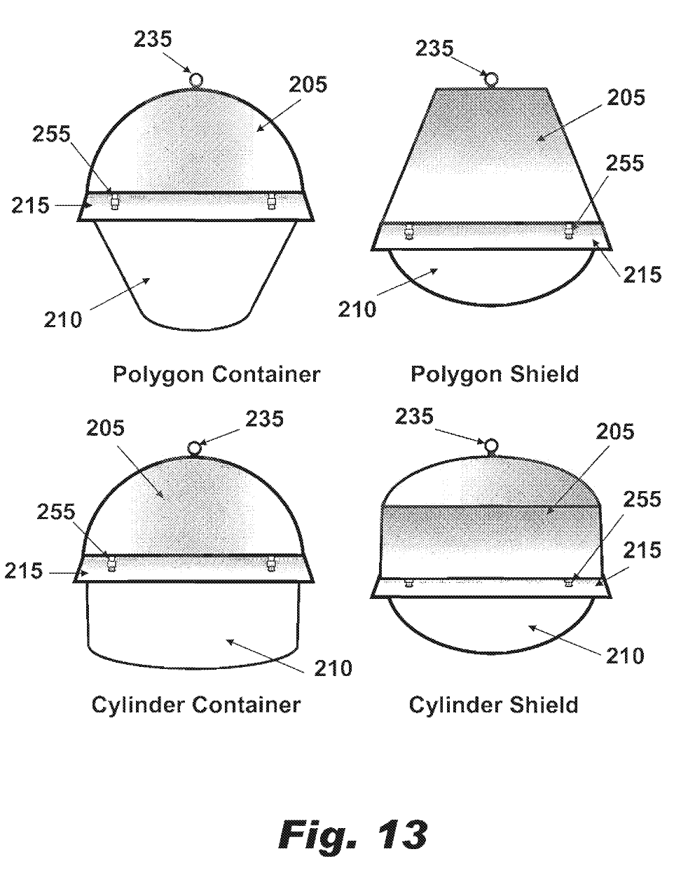

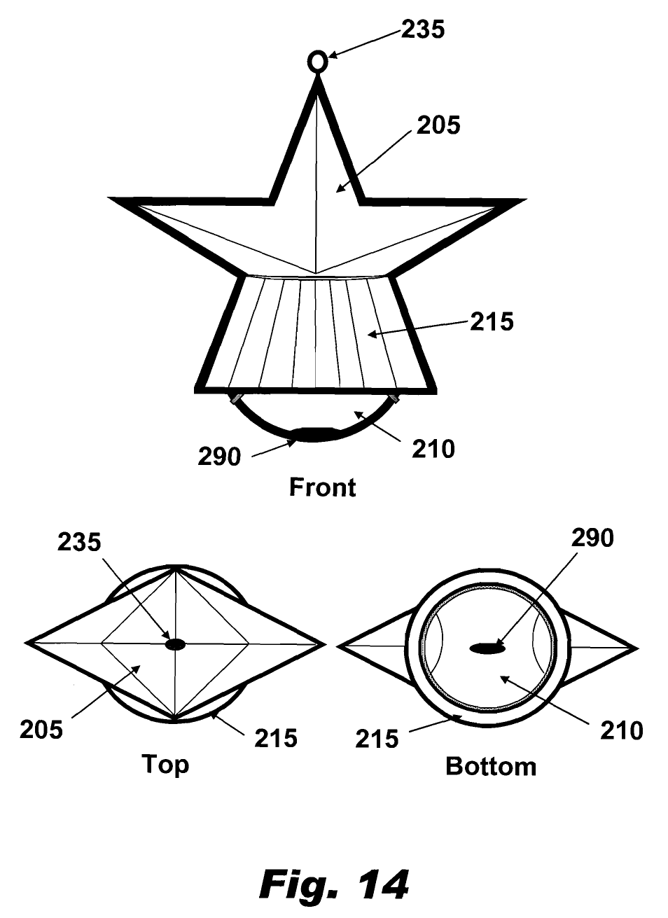

As disclosed, the ability to directionally deliver the fire extinguishing agent (60) to the fire lies in the skirt (215) feature of the shield (205). Accordingly, the shape and size of the shield (205) may be altered, but the spirit and the scope of principles of the disclosure is maintained as long as the skirt (215) is maintained. Whereas the angle of the skirt (215) may be modified in order to give a lesser or greater “limited” and “directional” coverage of the fire extinguishing media coverage. FIG. 13 is an example of an embodiment utilizing the features according to the present disclosure wherein the shield (205) and the base (210) are configured in to a polygon and a cylinder respectively. FIG. 14 is an example of an embodiment utilizing the features and principles of the present disclosure in a decorative item wherein the shield (205) is configured into a star shape. This embodiment is specifically designed for the festive season, for example, a Christmas celebration where the device can be suspended above the Christmas tree, particularly suitable for synthetic Christmas tree which are prone to catch fire from a burning candle or electrical fault of decorative lighting items.

In another embodiment, the automatic directional explosive-type fire suppression device (100) according to the present disclosure can be equipped with an optional wired or wireless alarm or sensing device which can act independently or attached to an alarm or sensing system such that activation of the device would trigger the alarm system or sensing device to activate and permit a warning audible sound to direct personnel to the location of incident. Such sensing devices are commonly found in the security industry and the automatic directional explosive-type fire suppression device (100) can be added to presently installed security systems for a minimum cost.

The forgoing detailed description is based on exemplary embodiments of a fire suppression device. The preceding description has been presented only to illustrate and describe embodiments and examples of the principles described. This description is not intended to be exhaustive or to limit these principles to any precise form disclosed. Many modifications and variations are possible in light of the above teaching.

1. An automatic directional fire suppression device comprising:
a container formed from two complimentary sections comprising a shield and a base;
a fire extinguishing agent contained within said container; and
an explosive charge assembly contained within said container;
wherein a portion of the shield is extended outward at an angle forming a skirt such that activation of the explosive charge within said container shatters the frangible base and the fire extinguishing agent is dispersed downward within a range of angles controlled by the skirt to extinguish or suppress a fire.

2. The automatic directional fire suppression device of claim 1, wherein the shield is made of a molded polyethylene or polyethylene based material configured to withstand heat and an explosion of the explosive charge without cracking or deforming.

3. The automatic directional fire suppression device of claim 1, wherein the container has a spherical shape formed by said shield and base which are shaped as two complimentary hemispheres

4. The automatic directional fire suppression device of claim 1, wherein the base is made from rigid non-hazardous lightweight low-density material providing uniform fragmentation upon activation of the explosive charge.

5. The automatic directional fire suppression device of claim 1, wherein the base is made from styrofoam.

6. The automatic directional fire suppression device of claim 1, wherein the base comprises an opening for receiving said fire extinguishing agent into said container and a fitted plug to seal said opening after the fire extinguishing agent has been introduced into said container.

7. The automatic directional fire suppression device of claim 1, wherein the explosive charge assembly comprises a fuse cord extending from an explosive charge to an exterior of said container where said fuse cord can be lit by said fire.

8. The automatic directional fire suppression device of claim 1, wherein the fire extinguishing agent comprises a dry power.

9. The automatic directional fire suppression device of claim 1, further comprising a bracket assembly for mounting the device to a wall.

10. The automatic directional fire suppression device of claim 9, wherein the bracket assembly comprises a mounting ring corresponding to a size of said base of said container.

11. The automatic directional fire suppression device of claim 9, wherein the bracket assembly comprises a mounting bar extending from a body; and a mating element on the mounting bar configured to attach to a corresponding mating element prepared on the shield of the container enabling the shield to be secured to the bracket assembly.

12. The automatic directional fire suppression device of claim 10, wherein the skirt of the shield is provided with holes for receiving locking elements for securing the shield to the mounting ring of the bracket assembly.

13. The automatic directional fire suppression device of claim 10, wherein the shield is provided with moldings having mating locking element for engaging corresponding locking elements on the mounting ring for securing the shield to the mounting ring of the bracket assembly.

14. The automatic directional fire suppression device of claim 13, wherein the locking elements for securing the shield to the mounting ring comprise a polyvinyl chloride (PVC) tie.

15. The automatic directional fire suppression device of claim 13, wherein the locking elements comprise any of a hinge, screw, release pin, lock key, Velcro strap or combination thereof.

16. The automatic directional fire suppression device of claim 1, further comprising a sensing device configured to trigger an alarm system in response to activation of said explosive charge assembly.

17. The automatic directional fire suppression device of claim 1, wherein the base is geometrically shaped as a polygon.

18. The automatic directional fire suppression device of claim 1, wherein the base is geometrically shaped as a cylinder.

19. The automatic directional fire suppression device of claim 1, wherein the shield is geometrically shaped as a polygon.

20. The automatic directional fire suppression device of claim 1, wherein the shield is geometrically shaped as a cylinder.

21. The automatic directional fire suppression device of claim 1, wherein the shield is geometrically shaped as a star.

22. The automatic directional fire suppression device of claim 1, wherein said container is protected with a moisture repellant.

23. A shield for a fire extinguishing device comprising a directional shield with a portion thereof extended outward at an angle forming a skirt, wherein, upon activation of the fire extinguishing device, the skirt controls dispersal of a fire extinguishing agent downward to target area defined by the angle of the skirt.

24. A bracket assembly for mounting a fire control device in a target area, said assembly comprising:
a body; and
a mounting bar extending from the said body, the mounting bar comprising a mating locking element for receiving a corresponding mating locking element disposed on a shield of the fire control device;
wherein said shield comprises a skirt for directing release of a fire extinguishing agent downward from said fire control device; and
wherein said corresponding mating locking element comprises adjustable supporting braces on said shield.
